(19) United States
(12) Patent Application Publication
(10) Pub. No.: US 2026/0302817 A1
(43) Pub. Date: Oct. 1, 2026

(54) SYSTEM AND METHOD FOR VEHICLE BATTERY CHARGE MAINTENANCE IN A STORAGE FACILITY

(71) Applicant: SS Solar LLC, Gilbert, AZ (US)

(72) Inventors: Gregory Martin ELLSWORTH, Gilbert, AZ (US); Jared Samuel SLUSSER, Temecula, CA (US)

(21) Appl. No.: 19/093,153

(22) Filed: Mar. 27, 2025

(51) Int. Cl. H02J 7/00; B60R 16/03; H02J 7/35

(52) U.S. Cl. CPC H02J 7/875; H02J 7/35; H02J 7/485; H02J 7/50; H02J 7/70; H02J 7/825; H02J 7/933; B60R 16/03

(57) ABSTRACT

A storage facility with a plurality of storage spaces and a plurality of charge controllers. Each storage space has a solar panel and an area for storage of a vehicle. The solar panel is configured to convert incident sunlight to electric potential energy. The area for storage includes an electrical power connection that receives the electric potential energy from the solar panel and provides this power to the user to charge the vehicle battery. Each solar panel is electrically isolated from the solar panels of adjacent storage spaces and each storage space is electrically isolated from other storage spaces. The charge controller is configured to be installed in a storage space and electrically couple with the solar panel through the electrical power connection. Once installed in a storage space, the charge controller is configured to work with the solar panel to provide off-grid trickle charging to the vehicle battery.

### TECHNICAL FIELD

This document relates to a system and method for vehicle battery charge maintenance in a storage facility.

### BACKGROUND

Storage facilities for recreational vehicles (RVs), boats, motorcycles, and seasonal-use automobiles provide owners with secure locations to store their vehicles for extended periods, particularly during off-seasons when they are not in use. These facilities serve a crucial function by ensuring that vehicles remain protected from the elements, theft, and other environmental factors. However, one of the most common and persistent challenges faced by both vehicle owners and facility managers is battery depletion. Prolonged storage without regular use can cause vehicle batteries to lose their charge, preventing the vehicle from starting when the owner is ready to use it again. In addition to causing inconvenience and delays, this depletion can also lead to reduced battery lifespan, as deep discharges over extended periods are known to accelerate the wear and deterioration of battery cells. As a result, vehicle owners are often required to replace batteries more frequently, which can lead to unexpected and costly maintenance expenses.

In an effort to mitigate these issues, many vehicle owners attempt to use the electrical outlets provided by the storage facility to maintain their vehicle's battery charge. They may connect various charging devices, including battery maintainers, conventional chargers, or inverters, which provide a continuous trickle charge to prevent the battery from depleting entirely. Unfortunately, this practice can introduce a series of new problems. One of the primary risks arises from improper use of the facility's electrical outlets and infrastructure. Vehicle owners may plug in high-current-draw appliances, such as space heaters, refrigerators, power tools, or air conditioning units, which can place excessive strain on the facility's electrical system. This overload can exceed the system's intended capacity, potentially causing circuit breakers to trip or even leading to a complete electrical failure in the storage facility. In the case of RVs, the owner may attempt to power the entire vehicle and its onboard systems, such as lights, appliances, and climate control, using the storage facility's electrical supply. This further amplifies the strain on the facility's power grid, as the high energy demand can lead to overheating of circuits, increased risk of fire hazards, and damage to both the vehicle and the facility's electrical infrastructure. In addition, even when the vehicle owner only plugs in a conventional charger or trickle charger, there is a risk of damage to the facility. This occurs because conventional chargers must be matched to the type of battery. For example, if the charger is designed for charging a lead-acid battery, but the battery being charged is a lithium ion battery, the battery may catch fire or explode. Some chargers include multiple settings for different types of batteries, but these chargers must be manually set to the correct mode, and thus still increase risk.

In conventional storage facilities, a single circuit is typically used by several vehicles within a designated storage area. While this arrangement might seem efficient, it introduces several critical problems, particularly when the circuit is overloaded or tripped. When multiple vehicle owners connect their vehicles to the same electrical circuit, the total power draw from all connected devices can quickly exceed the circuit's designed capacity. For example, if several vehicles are charging simultaneously and each vehicle is drawing power for extra systems (such as heaters, cooling units, refrigerators, or lights), the combined current demand may surpass the capacity of the circuit. This overload causes the circuit breaker to trip as a protective measure. While tripping the breaker is intended to prevent overheating and potential fire hazards, it can also lead to a number of logistical and operational issues for both the facility owner and the vehicle owners.

The primary issue arises when a breaker trip goes unnoticed, which is common in large storage facilities with many vehicles. Since multiple users share the same circuit, when a single breaker trips, it can affect the power supply to all connected vehicles, leaving them without charging or maintenance power. Vehicle owners may not immediately realize that their battery charging system has been disrupted, especially if the tripped breaker is located in a distant or hard-to-access part of the facility. As a result, the vehicles may remain disconnected from their power sources for an extended period, leading to depleted batteries when the owners return to retrieve their vehicles. This not only defeats the purpose of keeping the vehicle's battery maintained during storage, but also compounds the issue, requiring more time and resources to remedy the problem.

In the worst-case scenario, when the circuit breaker is repeatedly tripped and owners neglect to address the issue or fail to detect it, the vehicles may suffer from prolonged battery depletion. This can result in significant inconvenience, with some owners potentially having to replace batteries or seek professional assistance to revive their vehicles. The problem can also affect multiple vehicles simultaneously when one breaker protects several storage spaces or units in a given area. In such cases, a single vehicle that is drawing excessive power or causing a fault in the circuit can inadvertently impact other vehicles on the same line. This increases the complexity of troubleshooting and resolution, as the issue may not be immediately apparent to all users who are affected. In some cases, a fault in one vehicle can cause power failures for others, compounding the inconvenience for both the facility management and the owners.

Additionally, when a circuit is tripped, the process of manually resetting the breaker can be time-consuming and sometimes overlooked. In facilities where management or staff may not be readily available to address these issues, it can lead to extended periods of downtime for all vehicles connected to the affected circuit. If multiple circuits are used to serve large numbers of vehicles, troubleshooting which circuit is at fault can also become an arduous and time-consuming process.

In conclusion, while the intent behind utilizing a storage facility's electrical system for vehicle battery maintenance is to ensure vehicle readiness, improper use of these power sources creates significant risks. These risks include overloading the electrical system, causing circuit breakers to trip, leading to undetected charging failures, and increasing the potential for battery damage or safety hazards. These risks are not easily mitigated by the facility or the users.

### SUMMARY

Aspects of this document relate to a vehicle storage facility for long-term vehicle storage, the storage facility comprising a plurality of storage spaces, wherein each of the plurality of storage spaces comprises an area for storage of a vehicle having a battery, wherein the area for storage has an electrical power connection mounted to a surface bordering the area for storage, and a solar panel configured to convert incident sunlight to electric potential energy and provide the electric potential energy to the electrical power connection in the area for storage, wherein the solar panel is electrically isolated from solar panels of adjacent storage spaces of the plurality of storage spaces, and a plurality of charge controllers, wherein each of the plurality of charge controllers is configured to be installed in a storage space of the plurality of storage spaces, electrically couple with the solar panel of the storage space through the electrical power connection in the area for storage and with the battery of the vehicle in the storage space, operate in a charge mode and a maintenance mode, when in the charge mode, charge the battery using the electric potential energy from the solar panel, the charge controller having a charge profile configured to charge at least an absorbed glass mat battery, a lead-acid battery, and a lithium-ion battery, dynamically change a voltage applied to the battery based on a charge level of the battery, reduce the voltage applied to the battery as the battery approaches full charge capacity, and when in the maintenance mode, monitor the charge level of the battery and maintain a full charge, wherein, once installed in the storage space of the plurality of storage spaces, a charge controller of the plurality of charge controllers is configured to work with the solar panel to provide off-grid trickle charging to the battery of the vehicle, and wherein the storage facility is a covered storage facility.

Particular embodiments may comprise one or more of the following features. The charge profile may be configured to charge all types of rechargeable batteries. Each of the plurality of charge controllers may have a first electrical connector and a second electrical connector, wherein the first electrical connector is configured to couple with the electrical power connection to electrically couple the charge controller with the solar panel and the second electrical connector is a standardized electrical connector configured to electrically couple the charge controller with the battery of the vehicle. Each storage space of the plurality of storage spaces may be electrically isolated from other storage spaces of the plurality of storage spaces.

Aspects of this document relate to a vehicle storage facility for long-term vehicle storage, the storage facility comprising a plurality of storage spaces, wherein each of the plurality of storage spaces comprises an area for storage of a vehicle having a battery, and a solar panel configured to convert incident sunlight to electric potential energy, wherein the solar panel is electrically isolated from solar panels of adjacent storage spaces of the plurality of storage spaces, and a plurality of charge controllers each configured to be installed in a storage space of the plurality of storage spaces, electrically couple with the solar panel of the storage space and the battery of the vehicle in the storage space, charge the battery using the electric potential energy from the solar panel, the charge controller having a charge profile configured to charge at least an absorbed glass mat battery, a lead-acid battery, and a lithium-ion battery, and dynamically change a voltage applied to the battery based on a charge level of the battery, wherein, once installed in the storage space of the plurality of storage spaces, a charge controller of the plurality of charge controllers is configured to work with the solar panel to provide off-grid trickle charging to the battery of the vehicle, and wherein the storage facility is a covered storage facility.

Particular embodiments may comprise one or more of the following features. The area for storage may have an electrical power connection mounted to a surface bordering the area for storage and electrically coupled to the solar panel, wherein the charge controller is configured to electrically couple with the solar panel through the electrical power connection. Each of the plurality of charge controllers may be configured to reduce the voltage applied to the battery as the battery approaches full charge capacity. Each of the plurality of charge controllers may be configured to operate in a charge mode and a maintenance mode, wherein when in the charge mode, the charge controller is configured to charge the battery and when in the maintenance mode, the charge controller is configured to monitor the charge level of the battery and maintain a full charge. The charge profile may be configured to charge all types of rechargeable batteries. Each of the plurality of charge controllers may have a first electrical connector and a second electrical connector, wherein the first electrical connector is configured to electrically couple the charge controller with the solar panel and the second electrical connector is a standardized electrical connector configured to electrically couple the charge controller with the battery of the vehicle. Each storage space of the plurality of storage spaces may be electrically isolated from other storage spaces of the plurality of storage spaces.

Aspects of this document relate to a vehicle storage facility for long-term vehicle storage, the storage facility comprising a plurality of storage spaces, wherein each of the plurality of storage spaces comprises an area for storage of a vehicle having a battery, and a solar panel configured to convert incident sunlight to electric potential energy, and a plurality of charge controllers each configured to be installed in a storage space of the plurality of storage spaces, electrically couple with the solar panel of the storage space and the battery of the vehicle in the storage space, and charge the battery using the electric potential energy from the solar panel, the charge controller having a charge profile configured to charge at least an absorbed glass mat battery, a lead-acid battery, and a lithium-ion battery, wherein each storage space of the plurality of storage spaces is electrically isolated from other storage spaces of the plurality of storage spaces, and wherein, once installed in the storage space of the plurality of storage spaces, a charge controller of the plurality of charge controllers is configured to work with the solar panel to provide off-grid trickle charging to the battery of the vehicle.

Particular embodiments may comprise one or more of the following features. The solar panel may be electrically isolated from solar panels of adjacent storage spaces of the plurality of storage spaces. Each of the plurality of charge controllers may be configured to dynamically change a voltage applied to the battery based on a charge level of the battery. The area for storage may have an electrical power connection mounted to a surface bordering the area for storage and electrically coupled to the solar panel, wherein the charge controller is configured to electrically couple with the solar panel through the electrical power connection. Each of the plurality of charge controllers may be configured to reduce a voltage applied to the battery as the battery approaches full charge capacity. Each of the plurality of charge controllers may be configured to operate in a charge mode and a maintenance mode, wherein when in the charge mode, the charge controller is configured to charge the battery and when in the maintenance mode, the charge controller is configured to monitor a charge level of the battery and maintain a full charge. The charge profile may be configured to charge all types of rechargeable batteries. Each of the plurality of charge controllers may have a first electrical connector and a second electrical connector, wherein the first electrical connector is configured to electrically couple the charge controller with the solar panel and the second electrical connector is a standardized electrical connector configured to electrically couple the charge controller with the battery of the vehicle. The storage facility may be a covered storage facility.

The foregoing and other aspects, features, and advantages will be apparent from the DESCRIPTION and DRAWINGS, and from the CLAIMS if any are included.

### BRIEF DESCRIPTION OF THE DRAWINGS

Implementations will hereinafter be described in conjunction with the appended and/or included DRAWINGS, where like designations denote like elements.

FIG. 1 is a perspective view of a charge controller according to some embodiments.

FIG. 2 is a schematic of a storage facility according to some embodiments.

FIG. 3 is a front view of a storage facility according to some embodiments.

FIG. 4 is a side view of a solar panel of a storage facility according to some embodiments.

FIG. 5 is an abbreviated schematic of the flow of power through the storage facility according to some embodiments.

FIG. 6 is a side view of a storage space of a storage facility according to some embodiments with the solar panel mounted on a pole.

### DETAILED DESCRIPTION

Detailed aspects and applications of the disclosure are described below in the following drawings and detailed description of the technology. Unless specifically noted, it is intended that the words and phrases in the specification and the claims be given their plain, ordinary, and accustomed meaning to those of ordinary skill in the applicable arts.

In the following description, and for the purposes of explanation, numerous specific details are set forth in order to provide a thorough understanding of the various aspects of the disclosure. It will be understood, however, by those skilled in the relevant arts, that embodiments of the technology disclosed herein may be practiced without these specific details. It should be noted that there are many different and alternative configurations, devices and technologies to which the disclosed technologies may be applied. The full scope of the technology disclosed herein is not limited to the examples that are described below.

The singular forms “a,” “an,” and “the” include plural referents unless the context clearly dictates otherwise. Thus, for example, reference to “a step” includes reference to one or more of such steps.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented, but have been omitted for purposes of brevity.

Throughout the description and claims of this specification, the words “comprise” and “contain” and variations of the words, for example “comprising” and “comprises”, mean “including but not limited to”, and are not intended to (and do not) exclude other components.

As required, detailed embodiments of the present disclosure are included herein. It is to be understood that the disclosed embodiments are merely exemplary of the invention that may be embodied in various forms. Therefore, specific structural and functional details disclosed herein are not to be interpreted as limits, but merely as a basis for teaching one skilled in the art to employ the present invention. The specific examples below will enable the disclosure to be better understood. However, they are given merely by way of guidance and do not imply any limitation.

The present disclosure may be understood more readily by reference to the following detailed description taken in connection with the accompanying figures and examples, which form a part of this disclosure. It is to be understood that this disclosure is not limited to the specific materials, devices, methods, applications, conditions, or parameters described and/or shown herein, and that the terminology used herein is for the purpose of describing particular embodiments by way of example only and is not intended to be limiting of the claimed inventions. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

More specifically, this disclosure, its aspects and embodiments, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

The present disclosure is related to a controlled, facility-managed charging solution that ensures proper trickle charging for stored vehicles while preventing unsafe or excessive power usage. The system disclosed herein provides regulated power distribution tailored for battery maintenance while mitigating the risks associated with unauthorized appliance use or improper charging methods.

The present disclosure addresses the challenges of battery maintenance and thus reduces electrical overload issues, minimizes fire hazards, and ensures that stored vehicles receive the appropriate level of battery maintenance without compromising safety. The devices and systems of the present disclosure are configured to leverage renewable energy sources, such as solar power, to provide continuous trickle charging, ensuring that batteries remain functional and ready for use when needed.

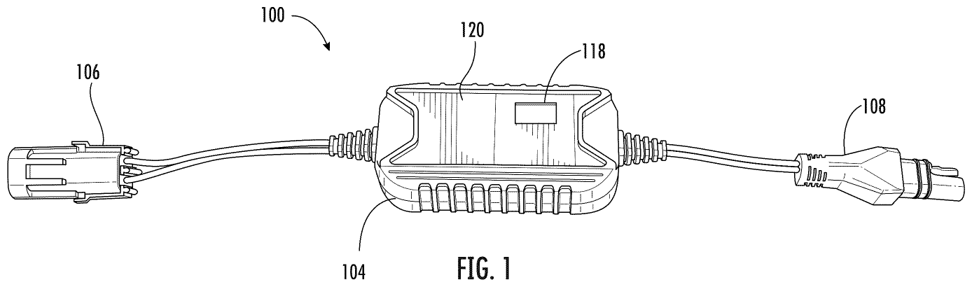

The present disclosure is related to a charge controller 100 that is configured to provide continuous trickle charging. As shown in FIG. 1, the charge controller 100 has a main body 104, a first electrical connector 106, and a second electrical connector 108. The first electrical connector 106 is configured to electrically couple with a solar panel 110. In some embodiments, the first electrical connector 106 is a non-standard electrical connector. This allows the charge controller 100 to be connected to an electrical source that is not available to other systems. For example, while the charge controller 100 can be connected to the electrical source, other systems like a refrigerator or an A/C unit cannot be connected because the electrical connection only works for the charge controller 100. Thus, the first electrical connector 106 may be a unique, non-standard electrical connector. The second electrical connector 108 is configured to electrically couple with a battery 112 of a vehicle. In some embodiments, different from the first electrical connector 106, the second electrical connector 108 is a standardized electrical connector. This allows the second electrical connector 108 to couple with any type of battery 112 that implements that standardized connection. In some embodiments, the second electrical connector 108 is configured to couple with alligator clips that can then be attached directly to the positive and negative terminals of the battery 112.

The main body 104 may have an indicator 118 on a surface 120 of the main body 104 that is configured to indicate to the user the status of the charge controller 100. The status of the charge controller 100 may be that the charge controller 100 is currently in a charge mode, that the charge controller 100 is currently in a maintenance mode, and/or that the charge controller 100 is running into some error. Any other status may be indicated.

In some embodiments, the charge controller 100 has built-in safety features to prevent overcharging, reverse polarity, over current, and short circuits. These features thus make it easier to use the charge controller 100 and safer for the charging environment, such as a storage facility (discussed in more detail below), and for the electrical circuit to which the charge controller 100 is connected.

The charge controller 100 may be configured to operate in a charge mode and in a maintenance mode. When in the charge mode, the charge controller 100 is configured to charge the battery 112. The battery 112 may be any type of rechargeable battery. For example, the battery 112 may be an absorbed glass mat battery (AGM), a lead-acid battery, or a lithium-ion battery. Other types of batteries may also be implemented, including wet cell, gel cell, flooded, maintenance-free, deep cycle, sealed, LiFePO4 lithium, and lithium iron batteries.

The charge controller 100 may have a unique charge profile that is uniquely suited for charging any type of battery 112 without any manual or other adjustment of any settings on the charge controller 100. In some embodiments, the charge profile is configured to charge all types of rechargeable batteries. The charge controller 100 may be configured to charge any type of battery without requiring a change in mode, setting, or charge profile. Instead, the charge profile implemented by the charge controller 100 is designed to charge any type of battery without creating a hazard to individuals or the facility. The charge controller 100 is a one-size-fits-all charger. Thus, when using the charge controller 100, there is no need for a user to press a button or otherwise manually select a charging mode, and the user does not need to worry about matching the battery to the charger like with conventional chargers. In other words, the charger's charging signal wave patterns are configured to charge each of absorbed glass mat batteries, lithium ion batteries and lead-acid batteries, in addition to others, without a change in the charger settings. In addition, the charge controller 100 may be configured to dynamically change a voltage applied to the battery 112 based on a charge level of the battery 112. For example, if the battery 112 has a lower charge level, the charge controller 100 may be configured to apply a particular voltage that is suited for charging the battery 112 at that charge level, and once the battery 112 has charged to a higher charge level, the charge controller 100 may be configured to respond by applying a different voltage that is more suited for charging the battery 112 at that higher charge level. In particular, this is helpful in implementing trickle charging, where the goal is not to charge the battery 112 as quickly as possible, but instead to maintain the battery 112 with a working charge for a long period of time. Thus, once the battery 112 reaches or approaches a full charge capacity, the charge controller 100 may be configured to apply a smaller voltage to conserve energy. The charge controller 100 may thus be configured to reduce the voltage applied to the battery 112 as the battery 112 approaches full charge capacity.

When in the maintenance mode, the charge controller 100 may be configured to monitor the charge level of the battery 112 without actively charging the battery 112. If the charge level of the battery 112 dips below a predetermined threshold, the charge controller 100 may be configured to briefly charge the battery 112 to maintain a full charge and then stop charging again.

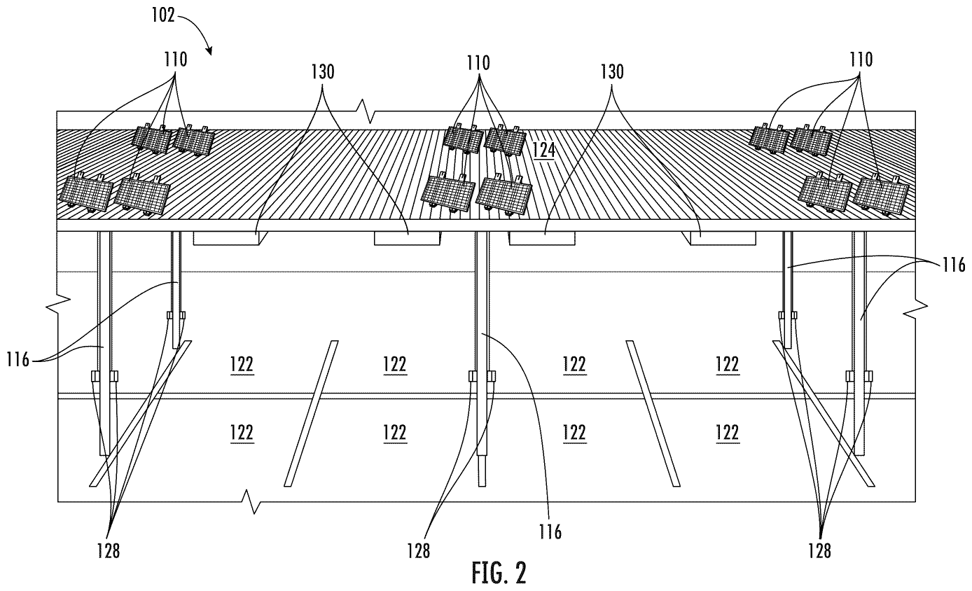

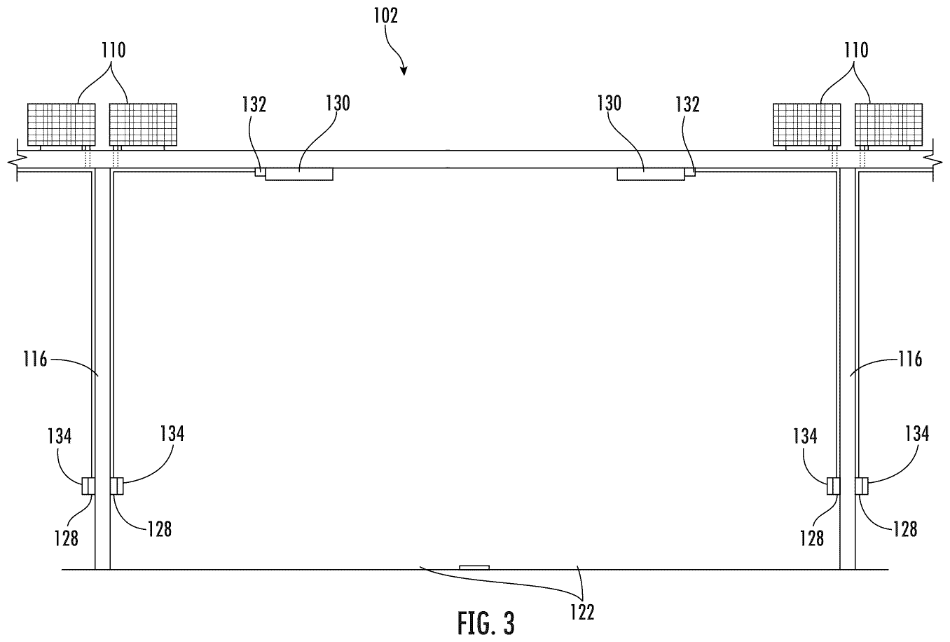

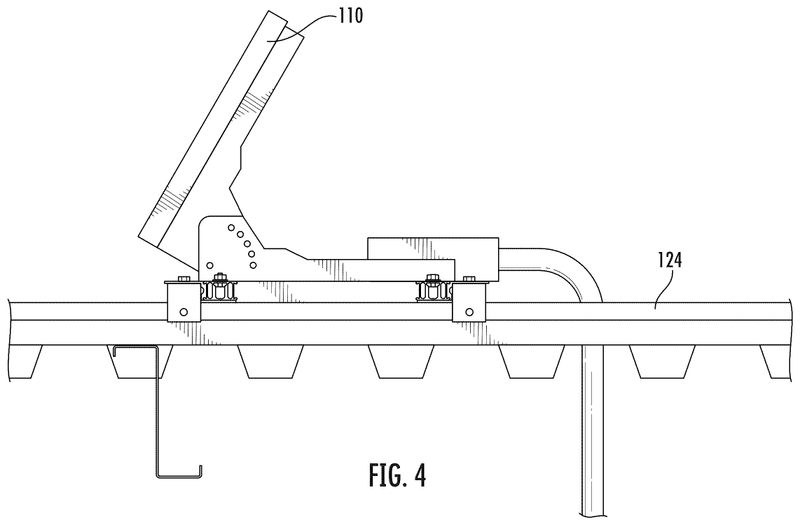

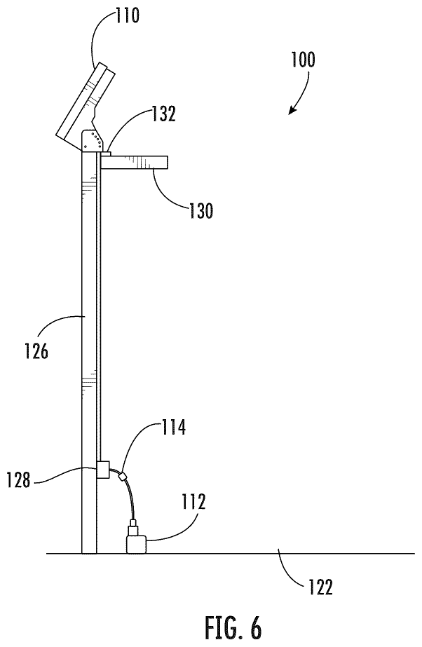

The present disclosure is also related to a storage facility 102 that is configured for long-term vehicle storage, as shown in FIGS. 2-3. The storage facility 102 provides a particularly useful scenario for the charge controller 100 disclosed above. The storage facility 102 may comprise a plurality of storage spaces 122. Each of the plurality of storage spaces 122 may comprise an area for storage of a vehicle, such as an RV, a boat, an ATV, a car, or a motorcycle. Any vehicle with a battery 112 may be stored. The area for storage may be a portion of a parking lot, a stall, a covered parking space, a garage, a storage locker, a storage unit, or any other area for storage. In some embodiments, the area for storage is not necessarily designed for storage of a vehicle and instead may be designed for storage of other articles or items. An electrical power connection 114 may be mounted to a surface 116 bordering the area for storage such as a wall, a roof support surface, or a pole. This provides support to the electrical power connection 114 instead of leaving the electrical power connection 114 to float around and potentially get in the way or get damaged. Each of the plurality of storage spaces 122 may also comprise a solar panel 110, shown in more detail in FIG. 4. The solar panel 110 is configured to convert incident sunlight to electric potential energy and provide the electric potential energy to the electrical power connection 114 in the area for storage. The solar panel 110 may have an adjustable angle to allow the solar panel 110 to be oriented more directly towards the sun. In some embodiments, the solar panel 110 is a 30 V solar panel. The solar panel 110 thus only provides power to the storage spaces 122 when the solar panel 110 is in the sunlight. This works well for trickle charging, where power is not needed constantly. Instead, it is suitable for the charge controller 100 to receive power only during particular portions of the day and to occasionally go without power for a day or two during cloudy conditions. In some embodiments, the solar panel 110 is mounted on a roof 124 covering the storage space 122 (see FIGS. 2-3). In some embodiments, the solar panel 110 is mounted on a pole 126 or other structure configured to raise the solar panel 110 and allow the solar panel 110 to receive more incident sunlight (see FIG. 6).

Of particular note, in some embodiments, each solar panel 110 is electrically isolated from other solar panels 110 of the plurality of storage spaces 122, as can be seen in the embodiment shown in FIG. 3, where each solar panel is electrically coupled to the corresponding junction box 128 and to the light 130, but is electrically isolated from the electrical circuit and components of adjacent storage spaces 122. Similarly, each storage space 122 of the plurality of storage spaces 122 may be electrically isolated from the other storage spaces 122. This helps to protect customers of the storage facility 102 from the scenario where a breaker is tripped, interrupting the supply of electricity to multiple storage spaces 122. Thus, each plurality of storage spaces 122 may be “off-grid,” meaning that the storage space 122 and/or the solar panel 110 is not electrically connected to public utilities, to an electrical grid, or to other, adjacent solar panels 110 or storage spaces 122. By isolating each storage space 122 and solar panel 110, any problems that arise, in particular from an individual misusing the system, will only affect a single storage space 122 and solar panel 110. In particular implementations, a solar panel 110 may provide electricity to two adjacent storage spaces 122, with just the two spaces being electrically isolated from other pairs of two storage spaces 122. In one particular embodiment, a solar panel 110 may provide electricity to four adjacent storage spaces 122. As with any of these examples, solar panel 110 may also include a solar panel array, and the use of the single, solar panel 110, should be understood to mean one or more panels of any wattage.

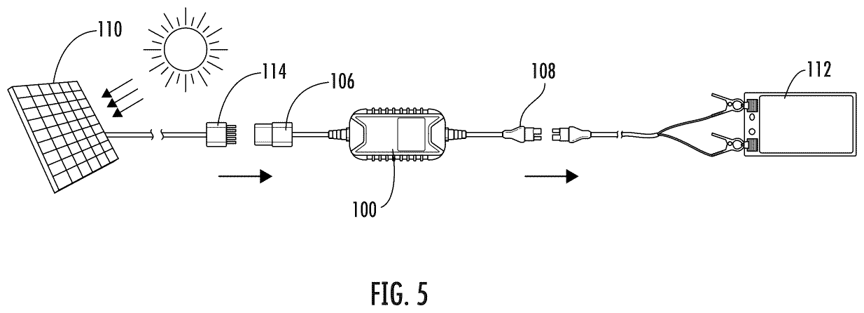

The storage facility 102 may also comprise a plurality of charge controllers 100 described above. These charge controllers 100 may be provided by the storage facility 102 to be installed in the storage spaces 122 to provide trickle charging to the batteries 112 in each storage space 122, as shown in FIGS. 3 and 5. Thus, each of the plurality of charge controllers 100 may be configured to be installed in a storage space 122 of the plurality of storage spaces 122. In addition, each charge controller 100 may be configured to electrically couple with the solar panel 110 of the storage space 122 through the electrical power connection 114 and with the battery 112 of the vehicle in the storage space 122, as described above. Once the charge controller 100 has been installed in a storage space 122 of the plurality of storage spaces 122, the charge controller 100 is configured to work with the solar panel 110 to provide off-grid trickle charging to the battery 112 of the vehicle, as shown in FIG. 5. The solar panel 110 converts incident sunlight into electricity and provides power to the charge controller 100, which then uses this power to charge or maintain the charge on the battery 112.

In some embodiments, each storage space 122 may have a junction box 128 that is positioned in or adjacent to the storage space 122 and/or the area for storage, as shown in FIGS. 2-3. The electrical power connection 114 may be housed in the junction box 128, and thus the junction box 128 may be mounted on the surface 116. In some embodiments, the junction box 128 is protected by an electrical cover 134, such as a weather-proof cover or some other cover configured to protect the junction box 128 and/or the electrical power connection 114. The junction box 128 is electrically coupled to the solar panel 110 and is configured to electrically couple with the charge controller 100. Thus, the junction box 128 is the connection point through which the charge controller 100 is configured to electrically couple with the solar panel 110. As noted above with respect to the first electrical connector 106 of the charge controller 100, the junction box 128 may comprise a unique, non-standard electrical connector that is configured to couple with the charge controller 100, but not with other, more typical electrical connectors. This allows the storage facility 102 to control what devices can be connected to and powered by the solar panel 110 and helps to prevent misuse and thus improves the safety and security of the storage facility 102.

In some embodiments, each storage space 122 of the storage facility 102 may also comprise a light 130 with a battery 132 (see FIGS. 3 and 6). The light 130 may be positioned to illuminate the storage space 122 in which the light 130 is installed. The battery 132 may be electrically coupled to the solar panel 110 such that, when the solar panel 110 generates power, the battery 132 is charged by the solar panel 110. The light 130 may be electrically coupled to the battery 132 so that the light 130 is configured to light up using power drawn from the battery 132. In some embodiments, the light 130 is configured to light up only when an ambient light level is lower than a threshold level. This helps to preserve the charge of the battery 132 until the light 130 is needed. In addition, the light 130 may be controllable by a switch such that a user can manually turn the light 130 on and off. In some embodiments, the light 130 is operably coupled to a motion sensor and is configured to light up when motion is detected in the vicinity of the light 130. Thus, the combination of the light 130 and the battery 132 may be configured to receive power from the solar panel 110 and provide illumination to the storage space 122 as needed/desired. In other particular embodiments, the battery 132 may be used to provide stored electricity to the electrical power connection 114, such as is referenced in relation to FIGS. 2-3 above, to enable charging through the charge controller 100 when the solar panel 110 is not generating electricity, such as at night or on a cloudy day.

Many additional implementations are possible. Further implementations are within the CLAIMS.

It will be understood that implementations of the charge controller include but are not limited to the specific components disclosed herein, as virtually any components consistent with the intended operation of various charge controllers may be utilized. Accordingly, for example, it should be understood that, while the drawings and accompanying text show and describe particular charge controller implementations, any such implementation may comprise any shape, size, style, type, model, version, class, grade, measurement, concentration, material, weight, quantity, and/or the like consistent with the intended operation of charge controllers.

The concepts disclosed herein are not limited to the specific charge controllers shown herein. For example, it is specifically contemplated that the components included in particular charge controllers may be formed of any of many different types of materials or combinations that can readily be formed into shaped objects and that are consistent with the intended operation of charge controllers. For example, the components may be formed of: rubbers (synthetic and/or natural) and/or other like materials; glasses (such as fiberglass), carbon-fiber, aramid-fiber, any combination therefore, and/or other like materials; elastomers and/or other like materials; polymers such as thermoplastics (such as ABS, fluoropolymers, polyacetal, polyamide, polycarbonate, polyethylene, polysulfone, and/or the like, thermosets (such as epoxy, phenolic resin, polyimide, polyurethane, and/or the like), and/or other like materials; plastics and/or other like materials; composites and/or other like materials; metals, such as zinc, magnesium, titanium, copper, iron, steel, carbon steel, alloy steel, tool steel, stainless steel, spring steel, aluminum, and/or other like materials; and/or any combination of the foregoing.

Furthermore, charge controllers may be manufactured separately and then assembled together, or any or all of the components may be manufactured simultaneously and integrally joined with one another. Manufacture of these components separately or simultaneously, as understood by those of ordinary skill in the art, may involve 3-D printing, extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled or removably coupled with one another in any manner, such as with adhesive, a weld, a fastener, any combination thereof, and/or the like for example, depending on, among other considerations, the particular material(s) forming the components.

In places where the description above refers to particular charge controller implementations, it should be readily apparent that a number of modifications may be made without departing from the spirit thereof and that these implementations may be applied to other implementations disclosed or undisclosed. The presently disclosed charge controllers are, therefore, to be considered in all respects as illustrative and not restrictive.

1. A vehicle storage facility for long-term vehicle storage, the storage facility comprising:
a plurality of storage spaces, wherein each of the plurality of storage spaces of the vehicle storage facility comprises:
an area for storage of a vehicle having a battery, wherein the area for storage has an electrical power connection mounted to a surface bordering the area for storage; and
a solar panel configured to convert incident sunlight to electric potential energy and provide the electric potential energy directly to the electrical power connection in the area for storage, wherein the solar panel is not electrically connected to solar panels of adjacent storage spaces of the plurality of storage spaces; and
a plurality of trickle charge controllers, wherein each of the plurality of trickle charge controllers is configured to:
be installed in a storage space of the plurality of storage spaces;
electrically couple with the solar panel of the storage space through the electrical power connection in the area for storage and with the battery of the vehicle in the storage space;
operate in a charge mode and a maintenance mode;
when in the charge mode, charge the battery using the electric potential energy directly from the solar panel, the trickle charge controller having a single charge profile configured to charge at least an absorbed glass mat battery, a lead-acid battery, and a lithium-ion battery without any adjustment of a trickle charge controller setting by a user;
dynamically change a voltage applied to the battery based on a charge level of the battery;
reduce the voltage applied to the battery as the battery approaches full charge capacity; and
when in the maintenance mode, monitor the charge level of the battery and maintain a full charge;
wherein charging signal wave patterns of the single charge profile are configured to charge each of the absorbed glass mat battery, the lead-acid battery, and the lithium-ion battery;
wherein, once installed in the storage space of the plurality of storage spaces, a trickle charge controller of the plurality of trickle charge controllers is configured to work with the solar panel to provide off-grid trickle charging to the battery of the vehicle; and
wherein the vehicle storage facility is a covered storage facility; and
wherein the solar panel is not electrically connected to public utilities or to an electrical grid.

2. The vehicle storage facility of claim 1, wherein the charge profile is configured to charge all types of rechargeable batteries.

3. The vehicle storage facility of claim 1, wherein each of the plurality of trickle charge controllers has a first electrical connector and a second electrical connector, wherein the first electrical connector is configured to couple with the electrical power connection to electrically couple the charge controller with the solar panel and the second electrical connector is a standardized electrical connector configured to electrically couple the charge controller with the battery of the vehicle.

4. The vehicle storage facility of claim 1, wherein each storage space of the plurality of storage spaces is not electrically connected to all other storage spaces of the plurality of storage spaces.

5. A vehicle storage facility for long-term vehicle storage, the storage facility comprising:
a plurality of vehicle storage spaces, wherein each of the plurality of vehicle storage spaces of the vehicle storage facility comprises:
an area for storage of a vehicle having a battery; and
a solar panel configured to convert incident sunlight to electric potential energy, wherein the solar panel is not electrically connected to solar panels of adjacent vehicle storage spaces of the plurality of vehicle storage spaces; and
a plurality of trickle charge controllers each configured to:
be installed in a storage space of the plurality of vehicle storage spaces;
electrically couple with the solar panel of the vehicle storage space and the battery of the vehicle in the vehicle storage space;
charge the battery using the electric potential energy directly from the solar panel, the trickle charge controller having a single charge profile configured to charge at least an absorbed glass mat battery, a lead-acid battery, and a lithium-ion battery without any adjustment of a trickle charge controller setting by a user; and
dynamically change a voltage applied to the battery based on a charge level of the battery;
wherein charging signal wave patterns of the single charge profile are configured to charge each of the absorbed glass mat battery, the lead-acid battery, and the lithium-ion battery;
wherein, once installed in the vehicle storage space of the plurality of vehicle storage spaces, a trickle charge controller of the plurality of trickle charge controllers is configured to work with the solar panel to provide off-grid trickle charging to the battery of the vehicle stored within the vehicle storage facility; and
wherein the vehicle storage facility is a covered storage facility; and
wherein the solar panel is not electrically connected to public utilities or to an electrical grid.

6. The vehicle storage facility of claim 5, wherein the area for storage has an electrical power connection mounted to a surface bordering the area for storage and electrically coupled to the solar panel, wherein the charge controller is configured to electrically couple with the solar panel through the electrical power connection.

7. The vehicle storage facility of claim 5, wherein each of the plurality of trickle charge controllers is configured to reduce the voltage applied to the battery as the battery approaches full charge capacity.

8. The vehicle storage facility of claim 5, wherein each of the plurality of trickle charge controllers is configured to operate in a charge mode and a maintenance mode, wherein when in the charge mode, the charge controller is configured to charge the battery and when in the maintenance mode, the trickle charge controller is configured to monitor the charge level of the battery and maintain a full charge.

9. The vehicle storage facility of claim 5, wherein the charge profile is configured to charge all types of rechargeable batteries.

10. The vehicle storage facility of claim 5, wherein each of the plurality of trickle charge controllers has a first electrical connector and a second electrical connector, wherein the first electrical connector is configured to electrically couple the charge controller with the solar panel and the second electrical connector is a standardized electrical connector configured to electrically couple the charge controller with the battery of the vehicle.

11. The vehicle storage facility of claim 5, wherein each storage space of the plurality of vehicle storage spaces is electrically isolated from other vehicle storage spaces of the plurality of vehicle storage spaces.

12. A vehicle storage facility for long-term vehicle storage, the storage facility comprising:
a plurality of storage spaces, wherein each of the plurality of storage spaces comprises:
an area for storage of a vehicle having a battery; and
a solar panel configured to convert incident sunlight to electric potential energy; and
a plurality of charge controllers each configured to:
be installed in a storage space of the plurality of storage spaces;
electrically couple with the solar panel of the storage space and the battery of the vehicle in the storage space; and
charge the battery using the electric potential energy from the solar panel, the charge controller having a single charge profile configured to charge at least an absorbed glass mat battery, a lead-acid battery, and a lithium-ion battery without any adjustment of a charge controller setting by a user;
wherein charging signal wave patterns of the single charge profile are configured to charge each of the absorbed glass mat battery, the lead-acid battery, and the lithium-ion battery;
wherein each storage space of the plurality of storage spaces is not electrically connected to other storage spaces of the plurality of storage spaces; and
wherein, once installed in the storage space of the plurality of storage spaces, a charge controller of the plurality of charge controllers is configured to work with the solar panel to provide off-grid trickle charging to the battery of the vehicle; and
wherein the solar panel is not electrically connected to public utilities or to an electrical grid.

13. The vehicle storage facility of claim 12, wherein the solar panel is not electrically connected to solar panels of adjacent storage spaces of the plurality of storage spaces.

14. The vehicle storage facility of claim 12, wherein each of the plurality of charge controllers is configured to dynamically change a voltage applied to the battery based on a charge level of the battery.

15. The vehicle storage facility of claim 12, wherein the area for storage has an electrical power connection mounted to a surface bordering the area for storage and electrically coupled to the solar panel, wherein the charge controller is configured to electrically couple with the solar panel through the electrical power connection.

16. The vehicle storage facility of claim 12, wherein each of the plurality of charge controllers is configured to reduce a voltage applied to the battery as the battery approaches full charge capacity.

17. The vehicle storage facility of claim 12, wherein each of the plurality of charge controllers is configured to operate in a charge mode and a maintenance mode, wherein when in the charge mode, the charge controller is configured to charge the battery and when in the maintenance mode, the charge controller is configured to monitor a charge level of the battery and maintain a full charge.

18. The vehicle storage facility of claim 12, wherein the charge profile is a single charge profile configured to charge all types of rechargeable batteries.

19. The vehicle storage facility of claim 12, wherein each of the plurality of charge controllers has a first electrical connector and a second electrical connector, wherein the first electrical connector is configured to electrically couple the charge controller with the solar panel and the second electrical connector is a standardized electrical connector configured to electrically couple the charge controller with the battery of the vehicle.

20. The vehicle storage facility of claim 12, wherein the storage facility is a covered storage facility.
